(19) United States
(12) Patent Application Publication
(10) Pub. No.: US 2005/0282115 A1
(43) Pub. Date: Dec. 22, 2005

(54) Maxillo-mandibular fixation system & method

(76) Inventor: Tewodros Gedebou, Los Angeles, CA (US)

Correspondence Address: MATTHEW A. NEWBOLES;STETINA BRUNDA GARRED & BRUCKER, Suite 250, 75 Enterprise, Aliso Viejo, CA, 92656, US

(21) Appl. No.: 10/874,874

(22) Filed: Jun. 22, 2004

(51) Int. Cl. A61C 5/00

(52) U.S. Cl. 433/215

(57) ABSTRACT

Improved maxillo-mandibular fixation systems and methods that deploy an inter-dental segment of floss/cord that can be substituted for conventional inter-dental wires. The inter-dental segment comprises an elongate segment of flexible, malleable material formed as a cord or floss having alternating portions formed thereon that are defined by a first floss portion having a first smaller size designed to be positioned or flossed between adjacent teeth, and a second segment or portion having a larger size that is operative to be interconnected with a conventional arch bar. In an alternative embodiment, the segment may comprise an inter-dental floss segment having first and second ends having a first larger size and an intermediate portion having a smaller size, the latter being operative to be looped around and flossed between opposed sides of one of a patient's teeth.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention is directed to improved maxillo-mandibular fixation systems and methods, and more particularly maxillo-mandibular fixation systems and methods that deploy a novel inter-dental segment that is operative to be flossed between the teeth to facilitate deployment and enhance patient comfort.

The procedure of maxillo-mandibular fixation (MMF) is well-known in the art. In this regard, such procedure is used to treat fractures of the facial bones, and in particular the maxilla (upper jaw) and mandible (lower jaw) by holding the boney parts thereof in their correct relationship while healing occurs. Generally, MMF involves placement of arch bars into the gingiva of the maxilla and mandible. Thereafter, a wire, which is typically either 25 or 26 gauge wire is positioned within the inter-dental spaces between the patient's teeth and thereafter connected to hooks, eyelets or other structures formed on the arch bar. Generally, the wires are formed as straight wires for inter-dental placement. Wires are also formed as wire “fishes” that are operative to interconnect the upper and lower arch bars to thus cause the patient's jaw/mouth to remain closed or fixed.

Despite the effectiveness of MMF to properly fix the patient's jaws into position, conventional MMF devices and methodology suffer from significant drawbacks. In particular, current MMF procedures are problematic due to the use of straight segments of wire having a high gauge that, because of its size and configuration, is difficult to maneuver between the teeth of the patient. In this regard, substantial difficulties arise in properly positioning the high gauge wires between the teeth, which can be exceptionally challenging given the substantial trauma to the gums typically experienced by patients undergoing MMF. Additionally, as the wires are being manipulated, the sharp ends may accidentally add injury to the soft tissue internal surfaces of the mouth as well as sticks to the surgeon's hands, with inherent risks of transmission of diseases such as HIV or Hepatitis. Moreover, even to the extent such high gauge wires can be positioned between the teeth, substantial patient pain and discomfort can arise due to the prolonged inter-dental placement of such wires. With respect to the latter, it has further been shown that the use of such high gauge wires can adversely effect teeth spacing both during and after the MMF procedure. Indeed, for these same reasons, removal of the inter-dental wires is exceptionally problematic and requires that such wires be forcibly removed from the inter-dental spaces, often times causing substantial pain to the patient. Moreover, the removal of such wires typically must be performed in an operating room or outpatient surgical facility as a safeguard to the extent any complications arise from such procedure, which, as a consequence, substantially increases the costs associated with MMF.

Accordingly, there is a substantial need in the art for an MMF system and method that substantially reduces, if not entirely eliminates, the aforementioned problems associated with conventional fixation systems. More particularly, there is a substantial need in the art for an inter-dental fixation mechanism that enables interconnectivity of a tooth to a conventional arch bar that avoids the various drawbacks and problems associated with heavy gauge wires currently utilized in MMF. There is a further need in the art for such an MMF system and method that can be readily deployed utilizing conventional surgical methodology, and in particular the conventional usage of arch bars and the like, is exceedingly simple to utilize and deploy, is of exceedingly simple construction and low cost, and eliminates the pain and substantial costs associated with the deployment and removal of MMF systems, and in particular the conventional inter-dental wires currently deployed in MMF systems.

### BRIEF SUMMARY OF THE INVENTION

The present invention specifically addresses and alleviates the above-identified deficiencies in the art. In this regard the present invention is directed to an improved MMF system and method that deploys an inter-dental segment formed as a floss or cord that can be substituted for conventional inter-dental wires currently utilized in MMF. According to a first embodiment, the system comprises an elongate segment of flexible, malleable material formed as a cord or floss having alternating portions formed therealong that are defined by a first floss portion having a first smaller size designed to be positioned or flossed between adjacent teeth, and a second segment or portion having a larger size that is operative to be interconnected with a conventional arch bar, such as Erich or Winters types of arch bars which are well-known to those skilled in the art. In an alternative embodiment, the invention comprises an inter-dental floss segment having first and second ends having a larger size and an intermediate portion having a smaller size, the latter being operative to be looped around and flossed between opposed sides of one of a patient's teeth. The enlarged end segments may then be interconnected to conventional arch bars as per conventional practice. In this respect, this embodiment closely mimics the use of wire “fishes” as currently used in MMF procedures, and can also be used for inter-arch attachment means.

The cord/floss segments utilized in the practice of the present invention may be formed from any of a variety of materials well-known to those skilled in the art. In this regard, such floss/cord may be formed from a flexible and malleable material, such as plastic, metal, alloys and the like. In all embodiments, however, such floss/cord segments will be operative to be easily positioned (i.e. flossed) between adjacent teeth yet still possess a structural rigidity, as provided by the enlarged portions of such cord/floss which can be utilized by the surgeon to fix the patient's jaw into position, that will enable the same to provide secure attachment to the arch bar. Advantageously, by utilizing such floss/cord segments that are able to more easily and rapidly be positioned between the patient's teeth allows for the MMF procedure to be performed far more rapidly, cost effectively and with a substantially higher degree of patient comfort than the use of wires having a uniform gauge or thickness. Furthermore, the smaller portion capable of being easily flossed between the teeth of the patient facilitates the rapid and easy removal of the MMF fixation systems of the present invention, which can be easily cut and removed in the office as opposed to current methods that require use of an operating room and anesthesia.

### BRIEF DESCRIPTION OF THE DRAWINGS

These as well as other features of the present invention will become more apparent upon reference to the drawings.

FIG. 1 is a side perspective view of the maxilla and mandible bones and teeth of an individual held together by an MMF system.

FIG. 2 is a perspective view of a length of a segment of a floss/cord constructed in accordance with a preferred embodiment for use in an MMF system to secure such system about the teeth of the patient.

FIG. 3 is a perspective view of a floss/cord segment constructed in accordance with another preferred embodiment of the present invention.

FIG. 3a is a perspective view of the floss segment depicted in FIG. 3 assuming a wire “fish” inter-arch configuration.

FIG. 4 is a perspective view of a segment of a floss/cord of the present invention shown positioned behind a portion of a tooth with thicker opposed ends thereof extending forwardly.

FIG. 5 is a side view taken along line 5-5 of FIG. 4.

### DETAILED DESCRIPTION OF THE INVENTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

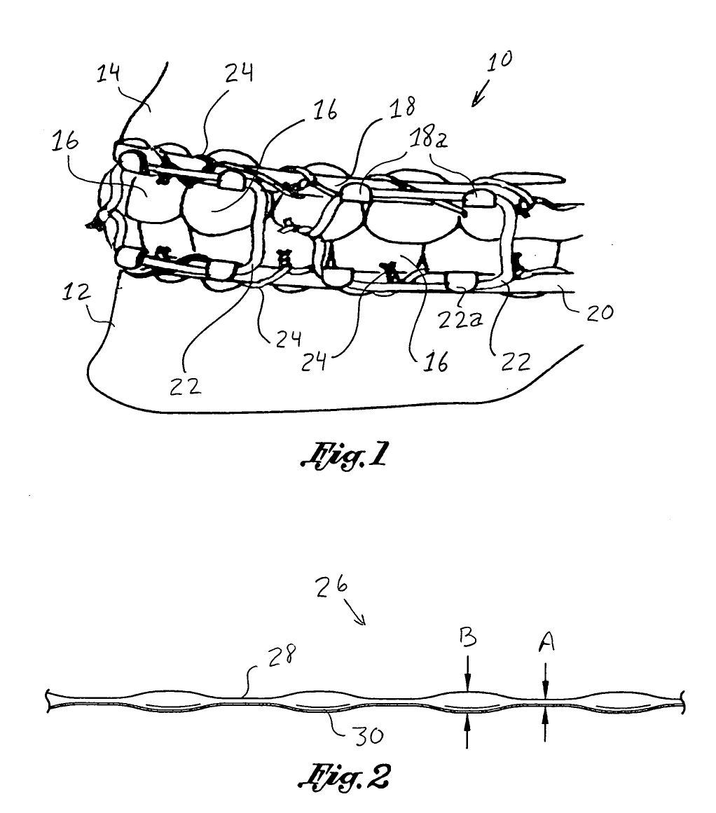

Referring now to the drawings and initially to FIG. 1, there is shown an MMF system 10 as utilized to fix the mandible 12 and maxilla 14 into position to thus facilitate the healing of facial fractures. As is well-known, facial fractures can and do frequently occur, and are typically caused by motor vehicle accidents, assaults, accidents and sports injuries. In this regard, the need to perform MMF procedures has and continues to be a commonly performed trauma-related procedure as well as elective jaw rearranging operations.

To facilitate the ability of the mandible 12 and maxilla 14 to be fixed into proper position, and especially such that upper and lower pairs of occlusive teeth 16 are maintained in their proper orientation, conventional MMF relies upon the use of arch bars 18, 20 that are positioned upon the upper and lower gums (i.e., gingiva) of the patient.

Such arch bars are well-known to those skilled in the art, and include such well-known types as the Erich arch bar, known to possess a greater degree of malleability and the Winters arch bar, which is stiffer and less malleable. Other types of arch bars are known in the art and extensively utilized. As illustrated, arch bar 18 is positioned about the upper gingiva and across the upper teeth whereas lower arch bar 20 is secured to the lower gingiva and extends about the lower teeth of the patient. Provided on each respective arch bar 18, 20 are hooks 18a, 22a that enable the same to be interconnected to wiring, such as 22, that is operative to secure the upper and lower arch bars 18, 20. Moreover, arch bars 18, 20 are operative to interconnect with wiring 24 that is positioned between, around and about the teeth 16 to thus provide secure fixation, restore occlusion between the teeth and reduce and stabilize the applicable fracture segments.

As discussed above, however, the use of conventional wire 24 is problematic. In this regard, such wires are typically formed from 25 or 26 gauge straight wires for inter-dental placement or as wire “fishes” for inter-arch connection between arch bars as illustrated by wire segment 22. The former is especially problematic insofar as the use of conventional wires is extremely difficult to place between teeth requiring general anesthesia, can cause significant patient discomfort for several weeks duration of its use, adversely affect the healing and positioning of the teeth during fixation, and can be extremely painful to remove without the use of deep sedation or general anesthesia.

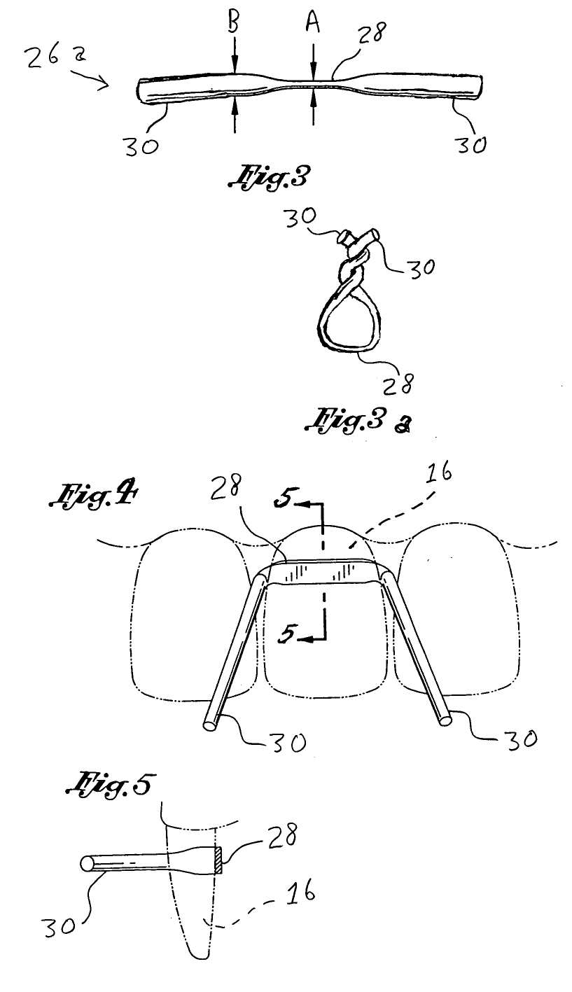

To address such shortcomings, there is illustrated in FIGS. 2 and 3, with initial reference to FIG. 2, a segment 26 of a floss/cord that is operative to serve as an inter-dental wire in a conventional MMF system. As illustrated, the segment 26 is formed from alternating segments defined by a first portion or length 28 having a first reduced cross sectional size, indicated by the letter A, and a second enlarged portion or length 30 having a larger cross sectional size, illustrated by the letter B. Such segment 26, which may be either formed from wire, plastic, alloy or any other material possessing sufficient malleability and strength, such as Teflon or Kevlar, that is designed to be utilized in place of conventional inter-dental wires, such as 25 or 26 gauge wire, but at the same time facilitate the ability of the segment 26 to be inter-dentally positioned within a patient, remain in such position during the healing process, and more easily removed therefrom as compared to conventional MMF inter-dental wires.

To achieve that end, the segment 26 is formed such that the smaller alternating portions 28 are configured to be flossed in between the inter-dental spaces, as per convention dental floss. In this regard, it is contemplated that such portions 28 will be readily fixed into position by merely flossing the same in between the patient's teeth, as opposed to the more rigorous and traumatic practice of forcibly inserting a thick gauge wire into such spaces. As will be appreciated by those skilled in the art, the alternating portions between 28 and 30 will be sized and configured to readily accommodate the ability of smaller portions 28 to be flossed between such alternating teeth.

Advantageously, however, enlarged alternating portions 30 will be sized and configured to facilitate attachment to the arch bars 18, 20, or otherwise be configured to provide a structural point of attachment or manipulation. Along these lines, it is contemplated that the floss/cord segments 26 of the present invention may be utilized in all types of fixation procedures, and especially for use in forming ivy loops or continuous loops which, as are well-known to those skilled in the art, comprise procedures whereby segments of material such as sutures and the like, are secured within the upper and lower inter-dental spaces and thereafter tied to one another to thus cause of occlusive teeth to remain compressibly affixed to one another.

Referring now to FIGS. 3 and 3a, there is shown a second embodiment 26a of the floss/cord segment for use in practicing MMF systems and methods of the present invention. As illustrated in FIG. 3, the embodiment 26a comprises an elongate segment having first and second ends 30 having a first larger size and an intermediate portion 28 having a reduced cross sectional size. In this regard, enlarged portions 30 will have an enlarged cross sectional size represented by the letter B, as per the embodiment depicted in FIG. 2, and segment 28 will have a reduced cross sectional size indicated by the letter A, per the embodiment depicted in FIG. 2. As opposed to being formed as an elongate segment of alternating enlarged 30 and reduced 28 sized portions, the embodiment in FIG. 3 may be utilized for placement about a single tooth such that the reduced sized portion 28 is flossed behind a single tooth with the enlarged portion 30 extending therefrom, as illustrated in FIG. 4. In this respect, the enlarged end portions 30, which in use will extend from behind the tooth to which it is secured, can be manipulated to be attached to an arch bar or other point of fixation. As illustrated in 3a, there is shown a configuration of such embodiment assuming a “fish” configuration. Such configuration, as will be appreciated by those skilled in the art, may be utilized for not only inter-dental placement, but for use in inter-arch connection. With respect to the former, it will be appreciated that portion 28 will be positioned behind the single tooth with the enlarged portions 30 extending forwardly therefrom, the latter being wrapped about each other in a helical formation to form the wire “fish”.

Referring now to FIGS. 4 and 5, and initially to FIG. 4, there is shown the advantageous manner by which the floss/cord segments of the present invention facilitate the ability of MMF systems to be secured into position without aggravating or inducing the trauma, discomfort and difficulty in removal associated with conventional inter-dental wires. As illustrated, portion 28 is easily positioned behind tooth 16 such that enlarged portions 30 extend forwardly therefrom. Reduced portion 28 need only be flossed into position and not otherwise forcibly placed between adjacent teeth as is conventional practice.

To facilitate the ability of the reduced portion 28 to be flossed into position behind respective ones of the patient's teeth, the same, in lieu or in addition to having a reduced size, may have a flattened or tapered configuration, such as the flattened configuration shown in FIGS. 4 and 5, which thus facilitates the ability of the segments to be flossed between teeth. Accordingly, it should be recognized that the present invention expressly recognizes that the portion 28 may take a variety of shapes and configurations that can facilitate inter-dental placement, as well as removal from its seated, flossed position. Along these lines, it is contemplated that to facilitate such placement, all or a portion of the segment 26 may be waxed or otherwise formed to have a preferred texture that facilitates placement between and removal from the inter-dental spaces between the patient's teeth. With respect to the latter, it is contemplated that by virtue of the reduced size of portion 28 of the segments utilized in the practice of the present invention, the same can readily be removed from a patient's teeth by merely removing the same via simple manipulation per conventional flossing practice after a much easier division, as compared to untwisting the wires prior to cutting with a wire cutter and then forcefully pulling the wire segment through the gums. As such, it is contemplated that the removal of such segments 26 is part of the termination of the MMF procedure can be performed in a very rapid, atraumatic manner in an office based setting. As is well-known, conventional practice requires MMF systems to be removed in a surgical facility, at substantial expense and discomfort to the patient. By utilizing the segments of the present invention, however, it is contemplated that such conventional practices will be substantially reduced, if not entirely eliminated.

Additional modifications and improvements of the present invention may also be apparent to those of ordinary skill in the art. For example, it is contemplated that the alternating portions 28, 30 formed along segment 26 may be formed as separate segments and/or from separate materials. Along these lines, one such construction may involve the use of an elongate cord or suture that is operative to define the smaller portions 28 that further have formed therealong alternating larger segments formed thereon, the latter defined by cylindrical sleeves that are placed about such cord. Still further, such segments may be defined by alternating portions of plastic strings, cords or sutures to define one portion, such as smaller portion 28, whereas larger portions 30 are defined by wire segments. As a further consideration, it is contemplated that while the segment 26 of the present invention may be utilized with conventional arch bars, arch bars that may be optimal for use in the present invention will likely have to be modified from conventional design, and particularly with respect to the ability of the arch bars to interconnect with larger portions 30 as well as how the segment 26 may be affixed thereto. Such design considerations will be easily understood by those skilled in the art. Along these lines, because it is deemed advantageous to form the segment 26 from a malleable and/or flexible material, it is contemplated that the systems and methods of the present invention will likely that such segments 26 be either tied or fixed with a crimp system, button, or other like means. Still further, it is contemplated that a deployment mechanism may be utilized to facilitate the ability of the segment 26 to be positioned between teeth to thus facilitate proper surgical placement of the segment 26. Thus, the particular combination of parts and steps described and illustrated herein is intended to represent only certain embodiments of the present invention, and is not intended to serve as limitations of alternative devices and methods within the spirit and scope of the invention.

1. An inter-dental segment for use in the fixation of a patient's teeth comprising an elongate cord defined by first and second alternating portions wherein at least one portion is operative to facilitate inter-dental placement of said segment.

2. The segment of claim 1 wherein said portion for facilitating inter-dental placement is operatively configured to be flossed into position between adjacent teeth.

3. The segment of claim 1 wherein said first portions are characterized by a first cross sectional size and said second portions are characterized by a second cross sectional size, said second cross sectional size being greater than said first cross sectional size.

4. The segment of claim 3 wherein said first portions possessing said first cross sectional size are configured to be flossed between adjacent teeth.

5. The segment of claim 1 wherein said segment is formed from a malleable material selected from the group consisting of a metal, alloy and plastic.

6. The segment of claim 4 wherein said second portions are operative to be interconnected with an arch bar.

7. A segment for interconnecting a tooth to an arch bar for use in performing MMF, said segment comprising an elongate cord having first and second ends and defining an intermediate portion, and said intermediate portion having a first cross sectional size, said first and second ends having a second cross sectional size said first cross sectional size being smaller than said second cross sectional size, said first cross sectional size being operatively configured to be flossed between opposed inter-dental spaces of a single tooth of said patient undergoing said MMF procedure.

8. The segment of claim 7 wherein said segment is formed from a malleable material selected from the group consisting of metal, alloy and plastic.

9. A method of performing MMF comprising the steps:
a) securing at least one arch bar within the mouth of said patient;
b) providing an elongate segment having at least one portion formed thereon operatively configured to be flossed between at least one pair of adjacent teeth of said patient undergoing said MMF procedure;
c) flossing said portion of said segment provided in step b) within at least one inter-dental space between said at least one pair of teeth of said patient undergoing said MMF procedure; and
d) securing said segment flossed into position in step c) to said arch bar secured into position in step a).

10. The method of claim 9 wherein in step b), said segment includes a multiplicity of portions formed thereon such that each respective on of said portions is operative to be flossed between pairs of adjacent teeth of said patient.

11. The method of claim 10 wherein in step b), said segment is formed from a malleable material selected from the group consisting of metal, alloy and plastic.
